(19) United States
(12) Patent Application Publication
(10) Pub. No.: US 2012/0044264 A1
(43) Pub. Date: Feb. 23, 2012

(54) APPARATUS AND METHOD FOR PROVIDING AUGMENTED REALITY

(75) Inventors: In-Bum LEE, Seoul (KR); Jae-Hun LEE, Seoul (KR)

(73) Assignee: PANTECH CO., LTD., Seoul (KR)

(21) Appl. No.: 13/184,767

(22) Filed: Jul. 18, 2011

(30) Foreign Application Priority Data
Aug. 18, 2010 (KR) 10-2010-0079901

(51) Int. Cl. G09G 5/377

(52) U.S. Cl. 345/633

(57) ABSTRACT

An apparatus and method for providing augmented reality (AR) includes acquiring an image of a real world including a first object, setting the first object as a reference object, acquiring a photographing position, a photographing direction, and a distance value between the reference object and the photographing position, acquiring map information corresponding to the photographing position and a photographing direction, mapping the reference object to the map information by using the acquired distance value, detecting AR information of the objects from the map information, and outputting the detected AR information.

### CROSS-REFERENCE TO RELATED APPLICATION

This application claims priority from and the benefit under 35 U.S.C. §119(a) of Korean Patent Application No. 10-2010-0079901, filed on Aug. 18, 2010, which is incorporated by reference for all purposes as if fully set forth herein.

### BACKGROUND

1. Field

The following description relates to an augmented reality apparatus and method for providing information about an object as tag information.

2. Discussion of the Background

Augmented reality (AR) is a computer graphic scheme allowing a virtual object or information to be viewed as if the virtual object or virtual information were present in a real world environment by integrating the virtual object or virtual information with the real world environment.

Unlike conventional virtual reality, which may be limited to applications in a virtual space, AR further provides additional information that may not be easily obtained in the real world, by integrating virtual objects or virtual information with the real world. That is, unlike virtual reality, which may be applicable to limited fields, such as computer games, AR may be applicable to various types of real world environments. Because of its application to broader range of environments, AR has been spotlighted as a next generation display technology to be applied in a ubiquitous environment.

For example, if a tourist on a street in London points a camera of a mobile phone with a global positioning system (GPS) functionality, in a specific direction, AR information about a restaurant on the street or a shop having a sale may be superimposed on an image of the actual street and displayed to the tourist.

However, in using a conventional AR service providing system, a database for AR service may be constructed for each telecommunication company and, as a result, a large amount of time may be used to collect large amount of AR service data to support such a service.

### SUMMARY

Exemplary embodiments of the present invention provide an apparatus and method for providing augmented reality (AR) capable of reducing the time taken to collect AR service data.

Additional features of the invention will be set forth in the description which follows, and in part will be apparent from the description, or may be learned by practice of the invention.

Exemplary embodiments of the present invention provide a method for providing AR including acquiring an image of a real world including a first object; setting the first object as a reference object; acquiring a photographing position, a photographing direction, and a distance value between the reference object and the photographing position; acquiring map information corresponding to the photographing position and a photographing direction; mapping the reference object to the map information by using the acquired distance value; detecting AR information of the objects from the map information; and outputting the detected AR information.

Exemplary embodiments of the present invention provide an apparatus to provide AR, the apparatus including an image acquisition unit to acquire an image of a real world including a first object; a control unit to set the first object as a reference object; a sensor unit to determine a photographing position and direction information of the AR providing apparatus, and to measure the distance value of the reference object to the photographing position; a storage unit to store map information corresponding to the photographing position and a photographing direction, in which the control unit retrieves the map information from the storage unit, maps the reference object to map information according to the acquired distance value, and detects AR information of the reference object and the second object; and a display unit to output the acquired image and AR information of the reference object and the second object.

Exemplary embodiments of the present invention provide a method for providing AR, the method including acquiring an image of a real world including a first object and a second object; setting the first object as a reference object; acquiring a photographing position, a photographing direction, and a distance value between the reference object and the photographing position; acquiring map information corresponding to the photographing position and a photographing direction; and displaying the acquired image and AR information of the reference object and the second object, in which the acquiring the map information includes; identifying recognition information of the reference object; including the recognition information of the reference object with the recognition information of a target map object to identify a match, in which the target map object is an object on the map located according to the acquired distance value and photographing direction from the photographing position; mapping the reference object to the target map object; and detecting AR information of the reference object and the second object.

It is to be understood that both foregoing general descriptions and the following detailed description are exemplary and explanatory and are intended to provide further explanation of the invention as claimed. Other features will become apparent to those skilled in the art from the following detailed description, drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus to provide augmented reality (AR) according to an exemplary embodiment of the invention.

FIG. 2 is a flowchart illustrating a method for providing AR according to an exemplary embodiment of the invention.

FIG. 3 is a view illustrating a map of a surrounding environment around a photographing position according to an exemplary embodiment of the invention.

### DETAILED DESCRIPTION OF THE ILLUSTRATED EMBODIMENTS

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g., XYZ, XZ, YZ). Throughout the drawings and the detailed description, unless otherwise described, the same drawing reference numerals are understood to refer to the same elements, features, and structures. The relative size and depiction of these elements may be exaggerated for clarity, illustration, and convenience.

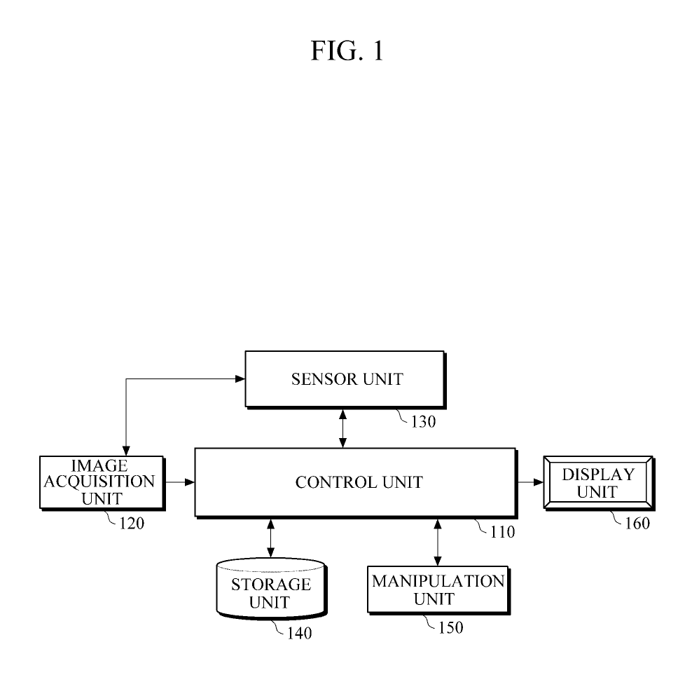

FIG. 1 is a block diagram illustrating an example of an apparatus to provide augmented reality (AR) according to an exemplary embodiment of the invention.

As shown in FIG. 1, an apparatus for providing augmented reality (AR) includes a control unit 110, an image acquisition unit 120, a sensor unit 130, a storage unit 140, a manipulation unit 150 and a display unit 160.

The control unit controls the image acquisition unit 120, the sensor unit 130, the storage unit 140, and the display unit 160 to provide an AR function. In addition, the control unit may control the enumerated components partly in response to the user input receiver through the manipulation unit 150. In an example, the control unit 110 may receive information sent by the image acquisition unit 120, process the information, and then output the received information to the display unit 160. The control unit 110 may be implemented as a hardware processor or a software module executable on a hardware processor. Details of the operation of the control unit 110 will be described later through a method of providing AR.

The image acquisition unit 120 acquires an image of the real world including objects and output the acquired image to the control unit 110. In an example, the image acquisition unit 120 may be implemented by a camera or an image sensor. In addition, the image acquisition unit 120 may be implemented by a camera that can enlarge, reduce, or rotate an acquired image automatically or through the control of the control unit 110. The control unit 110 outputs an image input from the image acquisition unit 120 to the display unit 160.

The sensor unit 130 senses the position of the AR providing apparatus, the direction of the AR providing apparatus, and a distance value between the AR providing apparatus and a target object. In an example, the sensor unit 130 may include a global positioning system (GPS) receiver to receive positional information signals from a GPS satellite, a gyro sensor to sense an azimuth angle and a tilt angle of the AR providing apparatus, and an accelerometer to measure a rotation direction and a rotation amount of the image acquisition unit 120.

The storage unit 140 stores map information and AR data representing various types of information, which are related to a real object that exists in the real world and on a defined map. In addition, the storage unit 140 may further store object recognition information used to recognize the target object. In an example, the map information may include information about at least one object present around a reference position. Further, the appropriate map information may be identified based on the position at which an image acquired by the image acquisition unit 120 is photographed (photographing position). Based on the photographing position information, map information corresponding to the obtained photographing position is detected from the storage unit 140. Further, the appropriate map information may be identified based on the photographing position with respect to the direction in which the image was photographed (photographing direction). Based on this configuration, map information corresponding to both the photographing position and the photographing direction may be identified from the storage unit 140.

The AR data may represent information related to a real object included in an image acquired by the image acquisition unit 120. As an example, if the target object included in the acquired image is that of a tree, the AR data of the tree may include the name of the tree, main habitations of the tree, and ecological characteristics of the tree displayed as a tag image. Further, the tag image may be superimposed on the image of the target object.

Object recognition information includes information used to recognize the target object. In an example, object recognition information may include attribute values, such as outlines or colors of the object. The control unit 110 may identify the target object by comparing object recognition information identified in the acquired image, with attribute values of the object recognition information stored in the storage unit 140. In an example, storage unit 140 may be implemented as a built-in component, or as an external component, which receives data through a network. In the latter case, the AR providing apparatus according to this example may further include a communication interface enabling network communication.

The manipulation unit 150 may be a user interface and may receive information from a user. In an example, the manipulation unit 150 may include a key panel to generate key data, a touch screen and/or a mouse. In an example, a selection of a reference object may be made through the manipulation unit 150. More specifically, the manipulation unit 150 may receive selection information of a reference object and may request information for AR service about surroundings of a reference object. Alternatively, the reference object may be selected according to reference conditions or rules.

The display unit 160 outputs an image acquired by the image acquisition unit 110, stored or inputted by a different source, to be viewed by the user. In addition, the display unit 160 may output AR information of the target object included in the image acquired by the image acquisition unit 110. Although the manipulation unit 150 and the display unit 160 shown in FIG. 1 are illustrated as separate units, aspects of the present invention are not limited thereto such that the manipulation unit 150 and the display unit 160 may integrated with each other, for example, as in a touch screen.

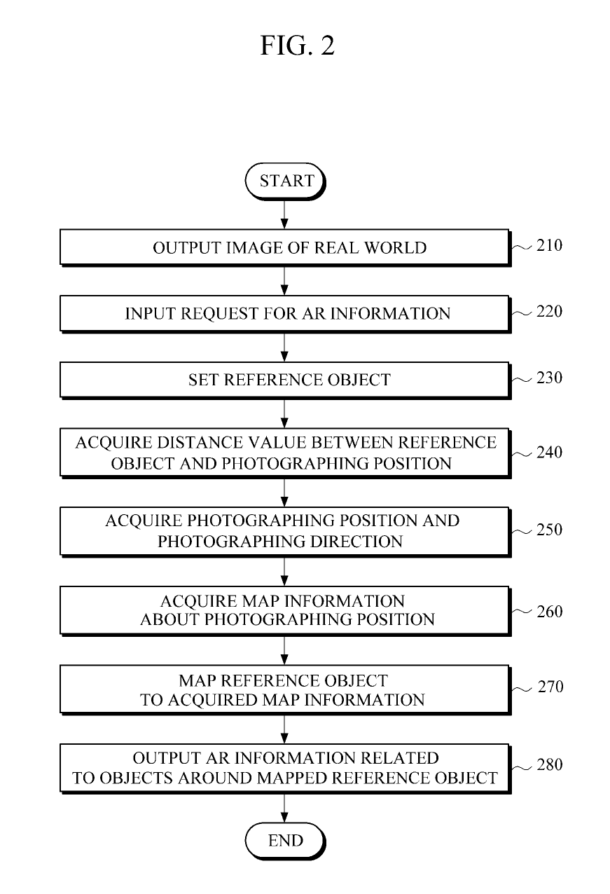

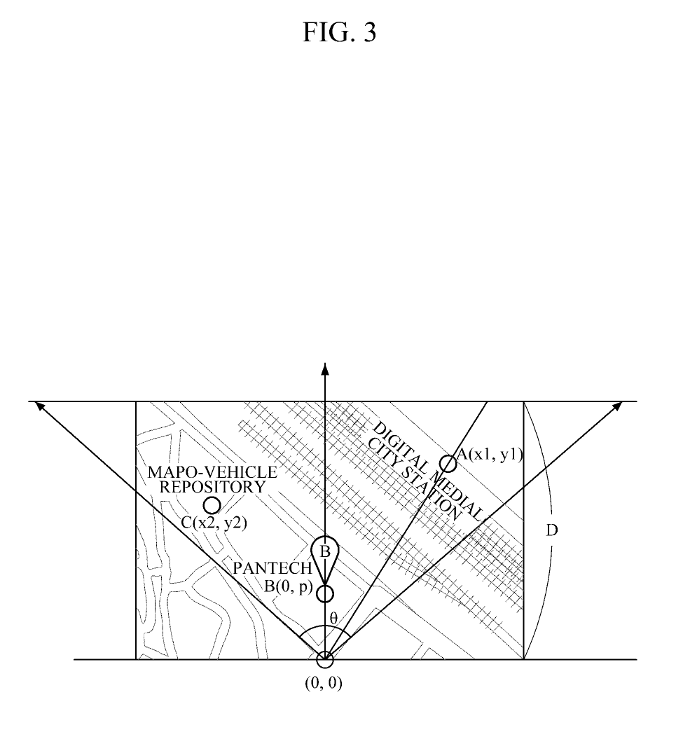

Hereinafter, a method for providing AR will be described with reference to FIG. 2 and FIG. 3.

FIG. 2 is a flowchart illustrating a method for providing AR according to an exemplary embodiment of the invention.

As shown in FIG. 2, the control unit acquires an image of the real world through the image acquisition unit by receiving key data input using the manipulation unit, and outputs the acquired image through the display unit (210). Next, upon receipt of a request for AR information about a target object included in the acquired image (220), the control unit sets one object from one or more objects included in the image as a reference object (230).

The setting of a reference object may be implemented in various forms.

In one example of setting a reference object, the control unit may automatically select a reference object based on a set of reference conditions or rules. More specifically, the most easily recognizable object from objects included in the image may be set as a reference object. In another example of setting a reference object, the control unit may set a reference object from one or more selectable objects identified in the image according to the user selection received. That is, user inputted selection of a reference object may be received through a manipulation unit.

The control unit acquires a distance value between the reference object and the photographing position (240). For example, the sensor unit 130 may calculate a distance value by emitting light to the reference object and then measuring the time at which the emitted light returns. Based on the measurement of time, the distance may be calculated by multiplying the speed of light with the measured time. The resulting distance may be outputted to the control unit.

The control unit acquires photographing position information at which the acquired image is photographed, and photographing direction information of the target object from the photographing position (250). If the acquired image is an image taken in real time, the control unit acquires photographing position information and photographing direction information of the AR providing apparatus by use of the sensor unit. However, if the acquired image is an image that was previously taken or provided from an external source, the control unit may receive photographing position information and photographing direction information from a user or from data associated with the image.

The control unit acquires map information corresponding to the acquired photographing position and the acquired photographing direction, from the storage unit (260). That is, the control unit acquires map information corresponding to a range determined by use of a photographing position and a photographing direction.

More specifically, the control unit searches for an object corresponding to the reference object among objects included in the map information and maps the searched object. The map information may be acquired by using the acquired photographing position, photographing direction and distance between the reference object and the AR providing apparatus (270). That is, an object present at a position which is located from the photographing position according to the distance value and direction (target map object) may be determined as the reference object. In this case, the control unit may acquire recognition information about the reference object from the image acquired in operation 210, and identify a reference object by comparing the recognition information of the reference object against the recognition information of the corresponding map target object stored in the storage unit. In an example, recognition information may include a company logo, name, a trademark symbol and other attributes that may be associated with the identity of a particular object. Thereafter, if the recognition information of the reference object matches up with the recognition information of the map target object, then the two respective objects are determined to be the same and the reference object is successfully mapped to the identified map. Accordingly, the surrounding objects that are located within the reference proximity to the reference object may be identified based on the identified reference object, and the AR information related to the surrounding objects are outputted (280).

FIG. 3 is a view illustrating a map of a surrounding environment around a photographing position according to an exemplary embodiment of the invention.

As shown in FIG. 3, the photographing position information is determined as the origin (0, 0) and object “PANTECH” located at position (B) is identified as a reference object. A coordinate space having a line connecting the position (B) of the reference object to the origin (0, 0) as a Y-axis is set. Accordingly, the reference object “PANTECH” with located at position (B) has a coordinate position of (0, p).

The control unit detects and outputs AR information about objects present around the reference object. That is, the control unit detects information about objects included in a range which is defined by a reference angle and a reference distance. Further, the range may be defined according to the received user input, or may be defined in real time if the image is displayed in real time in a video camera setting.

For example, information used to define the range may include a view depth (D) and a view angle (θ) based on a direction along which the reference object is viewed. Although not shown, the information about the range may be set by a user, or inputted in real time. Within the reference depth and the reference view angle defined, object “MAPO-VEHICLE REPOSITORY” is identified at position (C) and object “DIGITAL MEDIAL CITY STATION” is identified at position (D). In this manner, the control unit detects AR information related to the “DIGITAL MEDIAL CITY STATION” and “MAPO-VEHICLE REPOSITORY,” from the storage unit and outputs the detected AR information.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing augmented reality (AR), the method comprising:
acquiring an image of a real world comprising a first object;
setting the first object as a reference object;
acquiring a photographing position, a photographing direction, and a distance value between the reference object and the photographing position;
acquiring map information corresponding to the photographing position and a photographing direction;
mapping the reference object to the map information by using the acquired distance value;
detecting AR information of the objects from the map information; and
outputting the detected AR information.

2. The method of claim 1, wherein the setting of the reference object is performed according to reference rules.

3. The method of claim 1, wherein the setting of the reference object is performed by receiving selection information from a user.

4. The method of claim 1, wherein a second object is located within a reference range.

5. The method of claim 4, wherein the reference range is determined by a view depth and a view angle.

6. An apparatus to provide augmented reality (AR), the apparatus comprising:
an image acquisition unit to acquire an image of a real world comprising a first object;
a control unit to set the first object as a reference object;
a sensor unit to determine a photographing position and direction information of the AR providing apparatus, and to measure the distance value of the reference object to the photographing position;
a storage unit to store map information corresponding to the photographing position and a photographing direction,
wherein the control unit retrieves the map information from the storage unit, maps the reference object to map information according to the acquired distance value, and detects AR information of the reference object and the second object; and
a display unit to output the acquired image and AR information of the reference object and the second object.

7. The apparatus of claim 6, wherein the reference object is set according to reference rules.

8. The apparatus of claim 6, wherein the storage unit is located within the AR providing unit.

9. The apparatus of claim 6, wherein the storage unit is located apart from the AR providing unit.

10. The apparatus of claim 6, wherein, in order to map the reference object to map information, the control unit:
identifies recognition information of the reference object; and
compares the recognition information of the reference object with the recognition information of a target map object to identify a match,
wherein the target map object is an object on the map located according to the acquired distance value and photographing direction from the photographing position.

11. The apparatus of claim 6, wherein the sensor unit measures the distance value of the reference object to the photographing position by emitting a light to the reference object from the photographing position and measuring the amount of time it takes for the emitted light to be reflected back.

12. The apparatus of claim 6, wherein the sensor unit is configured to specify the photographing position, the photographing direction and the distance value between the reference object and the photographing position; and output the specified photographing position, the specified photographing direction and the specified distance value.

13. The apparatus of claim 6, further comprising a manipulation unit to receive user input.

14. The apparatus of claim 13, wherein the control unit sets the reference object by receiving selection information about the reference object from a user through the manipulation unit.

15. The apparatus of claim 6, wherein the second object is located within a reference range.

16. The apparatus of claim 15, wherein the reference range is defined by a depth and a view angle.

17. A method for providing augmented reality (AR), the method comprising:
acquiring an image of a real world comprising a first object and a second object;
setting the first object as a reference object;
acquiring a photographing position, a photographing direction, and a distance value between the reference object and the photographing position;
acquiring map information corresponding to the photographing position and a photographing direction,
wherein the acquiring the map information comprises;
identifying recognition information of the reference object;
comparing the recognition information of the reference object with the recognition information of a target map object to identify a match, wherein the target map object is an object on the map located according to the acquired distance value and photographing direction from the photographing position;
mapping the reference object to the target map object; and
detecting AR information of the reference object and the second object; and
displaying the acquired image and AR information of the reference object and the second object.
